(19) United States
(12) Patent Application Publication
(10) Pub. No.: US 2007/0039219 A1
(43) Pub. Date: Feb. 22, 2007

(54) Garden marker device

(76) Inventor: Roger Wallace, Burnettsville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/491,619

(22) Filed: Jul. 24, 2006

Related U.S. Application Data
(60) Provisional application No. 60/705,404, filed on Aug. 4, 2005.

(51) Int. Cl. G09F 23/00

(52) U.S. Cl. 40/645

(57) ABSTRACT

A garden marker device is disclosed that includes, in one embodiment, a frame, a seed packet, and a packet cover. The frame includes a receiving member and a supporting member. The seed packet has a first end, a second end, and a pair of sides. The seed packet is configured to fit onto the receiving member. Additionally, the seed packet may contain seeds. The packet cover has a top end and a pair of flaps. The pair of flaps defines an opening sized to receive the seed packet and the receiving member. In one embodiment, the packet cover covers both the seed packet and the receiving member.

### REFERENCE TO RELATED APPLICATIONS

The present application claims the benefit of U.S. Provisional Application No. 60/705,404, filed Aug. 4, 2005, which is hereby incorporated by reference in its entirety.

### BACKGROUND

The present disclosure generally relates to devices used in gardening and landscaping. Specifically, the present disclosure includes a garden marker device.

Several techniques and systems have been developed for marking or locating plants and vegetation in a garden or landscape. Gardeners will often plant rows of seeds of selected plants and the gardener usually will want to mark the type of seed planted in a particular row to identify the type of seed and the care instructions of the seedling and plant. One form of marking plants is inserting stakes or sticks in the soil at the end of a row with a seed packet placed over the stake. Often stakes or sticks are difficult to insert into soil without damaging the stick or breaking the stick, especially if the soil is hard and much pressure is exerted on the stick to insert it into the ground. Frequently a gust of wind will blow the packet off the stake leaving a bare stake without any identifier. Rain can weaken the material of the seed packet such that the seed packet will deteriorate and fall off the stake, also leaving a bare stake without any identifier.

### BRIEF DESCRIPTION OF THE DRAWINGS

FIG. 1 is a front perspective view of one embodiment of a garden marker device.

FIG. 2 is a front perspective view of one embodiment of a frame.

FIG. 3 is a front perspective view of another embodiment of a frame.

FIG. 4 is a front perspective view of a frame and seed packet.

FIG. 5 is a front perspective view of the embodiment depicted in FIG. 1.

FIG. 6 is a front perspective view of one embodiment of a packet cover.

FIG. 7 is a front perspective view of one embodiment of a seed stake.

FIG. 8 is a front perspective view of the embodiments depicted in FIGS. 6 and 7 and one embodiment of a frame.

### DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. Certain embodiments of the invention are shown in detail, although it will be apparent to those skilled in the relevant art that some features that are not relevant to the present invention may not be shown for the sake of clarity.

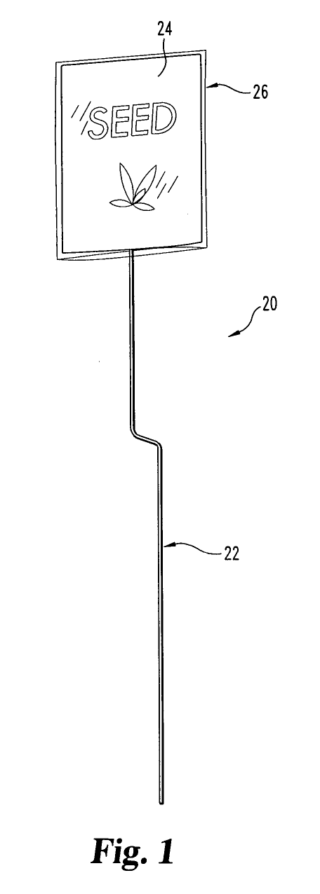

A garden marker device 20 is shown in FIG. 1. Garden marker device 20 includes a frame 22, a seed packet 24, and a packet cover 26. Garden marker device 20 may be included in a gardening kit. In one type of gardening kit, seed packet 24 contains seeds for planting. Optionally, in a gardening kit, seed packet 24 is contained in packet cover 26. In other embodiments, a gardening kit may contain gloves, seeds, or other gardening devices. In other forms, a gardening kit may include a plurality of frames 22, a plurality of seed packets 24, and a plurality of packet covers 26.

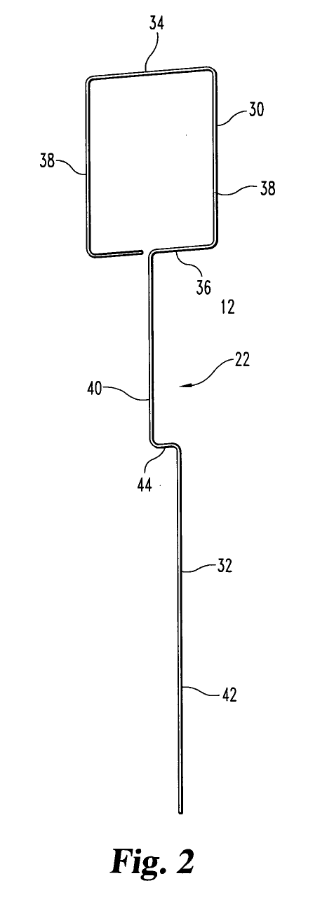

As illustrated in FIG. 2, frame 22 includes a receiving member 30 and a supporting member 32. Receiving member 30 is shaped to receive seed packet 24 and packet cover 26. In the illustrated embodiment, receiving member 30 is a rectangular shape; however, in other embodiments receiving member 30 may be shaped differently, such as, square, trapezoidal, circular, or oval, to name a few. As shown in FIG. 2, receiving member 30 includes a top edge 34, a bottom edge 36, and a pair of side edges 38.

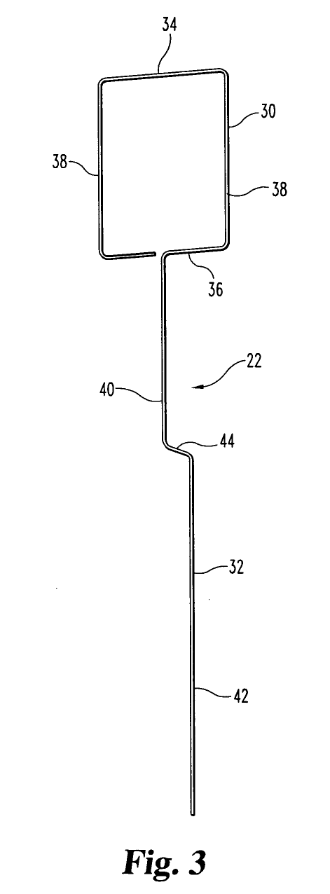

Supporting member 32 includes an upper portion 40 and a lower portion 42 separated from each other by an S bend 44. In one form, as shown in FIG. 2, S bend 44 is approximately perpendicular to both upper portion 40 and lower portion 42. In another form, as shown in FIG. 3, S bend 44 is oblique to both upper portion 40 and lower portion 42. In other forms, S bend 44 is circular, curved, corrugated, or rectangular, to name a few other shapes. As discussed below, a user may insert lower portion 42 into the ground or soil by applying force to S bend 44 and pushing lower portion 42 into the ground. In some embodiments, after insertion of lower portion 42 into the ground, S bend 44 increases the stability of garden marker device 20 as compared to a substantially straight stake.

Frame 22 may be made from one continuous piece of material to form receiving member 30 and supporting member 32. In other forms, frame 22 may be made from multiple pieces and attached together to form receiving member 30 and supporting member 32. Frame 22 is made from materials such as metal, plastic, or wood, to name a few.

In one embodiment, frame 22 has the following dimensions. Top edge 34 and bottom edge 36 each have a length of approximately 2⅞ inches, each of pair of side edges 38 has a length of approximately four inches, upper portion 40 has a length of approximately five inches, lower portion 42 has a length of approximately seven inches, and S bend 44 has a length of approximately one inch.

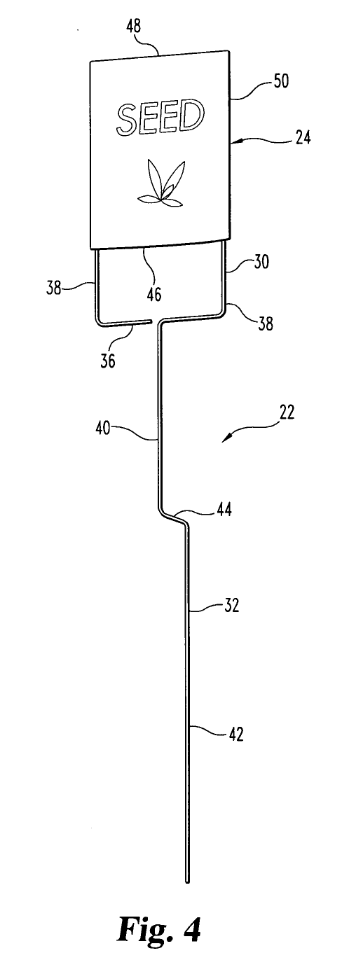

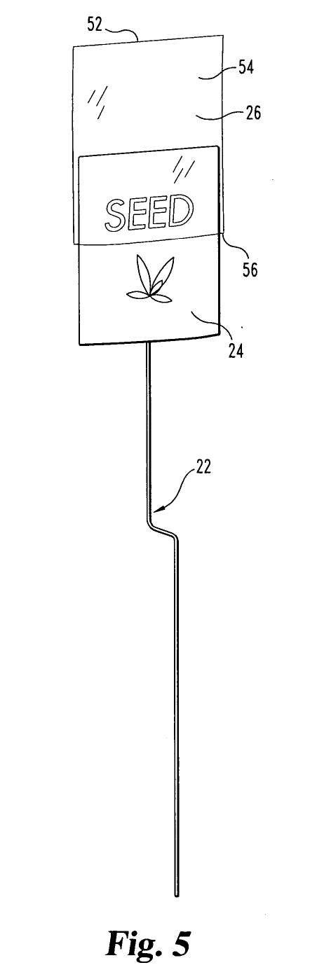

As shown in FIG. 4, seed packet 24 is shaped to snugly fit on receiving member 30 wherein seed packet 24 and receiving member 30 have similar shapes and sizes. In this embodiment, seed packet 24 is a rectangular shape; however in other embodiments seed packet 24 may be square, trapezoid, oval, or a circle, to name a few shapes. In other embodiments, seed packet 24 is shaped to fit on receiving member 30 wherein seed packet 24 and receiving member 30 have similar shapes but different sizes. Seed packet 24 includes a first end 46 and an opposite second end 48 separated by a pair of sides 50. Seed packet 24 may contain one or more seeds enclosed within first end 46, second end 48, and pair of sides 50. As discussed below, a user may open seed packet 24 at first end 46 and slide first end 46 over top edge 34 and onto receiving member 30. Optionally, first end 46 of seed packet 24 extends over bottom edge 36 as shown in FIG. 5. In other forms, a user may open seed packet 24 at second end 48 and slide second end 48 over top edge 34 and onto receiving member 30. Seed packet 24 may be made of paper, plastic, metal, or cardboard, to name a few materials.

In some embodiments, seed packet 24 may include written descriptions of the contents of seed packet 24, pictures, and directions to use garden marker device 20. In these embodiments, seed packet 24 may be used to designate plants or crops growing in a particular area if garden marker device 20 is planted in the ground near those plants. Optionally, seed packet 24 may contain an area in which a user can include a description or other information. Further, seed packet 24 may contain a trademark, servicemark, or logo. In one form, seed packet 24 contains the servicemark, SOW-U-KNOW™. In one embodiment, first end 46 and second end 48 of seed packet 24 are each approximately 3⅛ inches and each of pair of sides 50 is approximately 4¼ inches.

As illustrated in FIG. 5, packet cover 26 is shaped to fit over and cover seed packet 24. Packet cover 26 includes a top end 52 and a pair of flaps 54. Packet cover 26 defines an opening 56 between pair of flaps 54 sized to receive seed packet 24. In one embodiment described below, packet cover 26 fits snugly over both seed packet 24 and receiving member 30 (see FIG. 4) such that packet cover 26 protects seed packet 24 and any seeds therein from water or other liquids, wind, or the sun. Packet cover 26 may be made of plastic, metal, or a waterproof material. In one embodiment, packet cover 26 is made of a material that is transparent. In this embodiment, a user may see through the packet cover 26 to view seed packet 24 when packet cover 26 is placed over seed packet 24. In one form, top end 52 is approximately 3⅜ inches and each of pair of flaps 54 is approximately 4¾ inches.

In one form in which seed packet 24 contains seeds, either first end 46 or second end 48 of seed packet 24 is torn to expose seeds in seed packet 24. The user plants the seeds from seed packet 24 in soil. However, in other embodiments, either first end 46 or second end 48 is opened for placement of seed packet 24 onto receiving member 30. As illustrated in FIG. 4, first end 46 of seed packet 24 is placed onto top edge 34 (see FIG. 3) of frame 22. Seed packet 24 slides onto receiving member 30 such that second end 48 (see FIG. 4) may contact top edge 34 (see FIG. 3). Next, packet cover 26 is placed on seed packet 24. Opening 56 receives second end 48 (see FIG. 4) of seed packet 24 as shown in FIG. 5, and the remainder of seed packet 24 is inserted into opening 56 and into packet cover 26 such that top end 52 of packet cover 26 rests against second end 48 (see FIG. 4) as shown in FIG. 1. Lower portion 42 of frame 22 is inserted into the ground. In one form, a force may be applied to S bend 44 to assist in inserting supporting member 32 into the ground. In one embodiment, lower portion 42 and S bend 44 are inserted into the ground until S bend 44 is approximately ½ inch to one inch under the ground surface. In other embodiments, a portion of supporting member 32 of frame 22 is inserted into the ground before seed packet 24 and packet cover 26 are placed on receiving member 30.

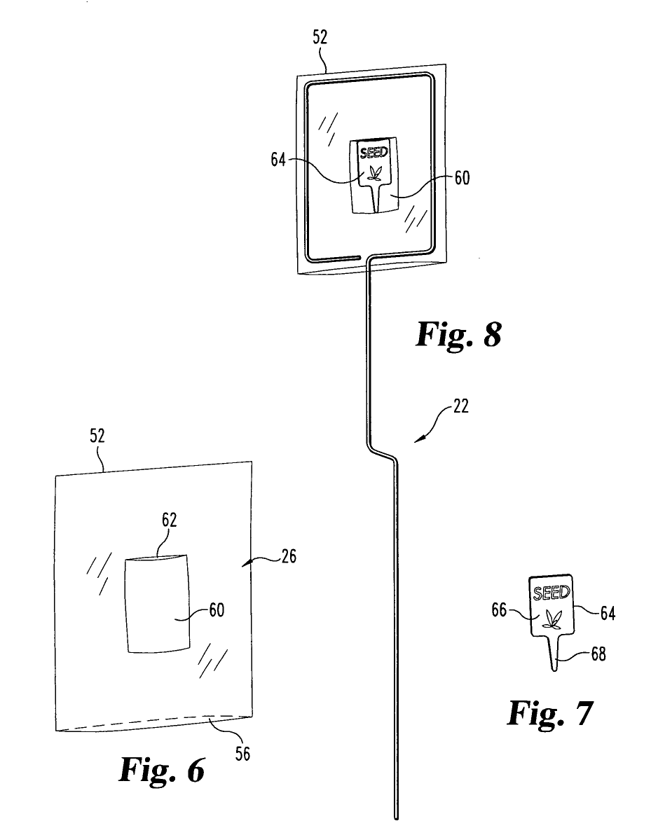

In another embodiment as illustrated in FIGS. 6, 7, and 8, packet cover 26 includes a pocket 60 defining an opening 62 for receiving a seed stake 64. Additionally, pocket 60 and seed stake 64 are similar sizes such that pocket 60 is sized to store seed stake 64. Pocket 60 is a rectangular shape; however, in other embodiments pocket 60 is shaped differently or configured differently. Pocket 60 may be square, oval, or trapezoidal, to name a few shapes. Further, pocket 60 may include a fastener for closing opening 62 such as a flap, zipper, or a snap, to name a few types of fasteners. Seed stake 64 has a first portion 66 extending from a second portion 68. As shown, first portion 66 is substantially rectangular in shape and second portion 68 is substantially triangular in shape. In other embodiments, first portion 66 and second portion 68 may be shaped differently such as square, circular, oval, or trapezoidal to name a few. Seed stake 64 may be made of paper, plastic, metal, or cardboard, to name a few materials. Seed stake 64 may include pictures, trademarks, directions to care for a particular plant, or other information. In one form, a user may not use seed packet 24 with packet cover 26 and seed stake 64. Instead the user may place the packet cover 26 directly onto frame 22 without placing seed packet 24 onto frame 22 as shown in FIG. 8. In this embodiment, second portion 68 is inserted into opening 62 such that first portion 66 is covered by pocket 60. Frame 22 is inserted into the ground as discussed above.

While the invention has been illustrated and described in detail in the drawings and foregoing description, the same is to be considered as illustrative and not restrictive in character, it being understood that only example embodiments have been shown and described and that all changes and modifications that come within the spirit of the invention are desired to be protected. All publications, patents, and patent applications cited in this specification are herein incorporated by reference as if each individual publication, patent, or patent application were specifically and individually indicated to be incorporated by reference and set forth in its entirety herein.

What is claimed is:

1. A gardening kit comprising:
a frame having a receiving member and a supporting member;
a seed packet having a first end and a second end separated by a pair of sides, said seed packet configured to fit onto said receiving member; and
a packet cover having a top end and a pair of flaps, said pair of flaps defining an opening sized to receive said seed packet and said receiving member.

2. The gardening kit of claim 1 wherein said seed packet contains a plurality of seeds.

3. The gardening kit of claim 1 wherein said packet cover is transparent.

4. The gardening kit of claim 3 wherein said packet cover is made of plastic.

5. The gardening kit of claim 1 wherein said receiving member, said seed packet, and said packet cover are substantially similar shapes.

6. The gardening kit of claim 5 wherein said receiving member, said seed packet, and said packet cover are substantially rectangular.

7. The gardening kit of claim 1 wherein said supporting member includes an upper portion, a lower portion, and an S bend, wherein said upper portion is connected to said lower portion by said S bend.

8. The gardening kit of claim 7 wherein said S bend is substantially perpendicular to both of said upper portion and said lower portion.

9. The gardening kit of claim 7 wherein said S bend is oblique to both of said upper portion and said lower portion.

10. An apparatus for insertion into soil to locate plants comprising:
a frame having a receiving member and a supporting member, wherein said supporting member includes an upper portion, a lower portion, and an S bend, wherein said upper portion is connected to said lower portion by said S bend; and
said receiving member is configured to receive a seed packet.

11. The apparatus of claim 10 wherein said receiving member is substantially a rectangular shape.

12. The apparatus of claim 10 wherein said S bend is substantially perpendicular to both of said upper portion and said lower portion.

13. The apparatus of claim 10 wherein said S bend is oblique to both of said upper portion and said lower portion.

14. The apparatus of claim 10 wherein said frame is made of metal.

15. The apparatus of claim 10 wherein:
said upper portion has a length of approximately five inches;
said lower portion has a length of approximately seven inches; and
said S bend has a length of approximately one inch.

16. The apparatus of claim 10 further comprising a packet cover having a top end and a pair of flaps, said pair of flaps defining an opening sized to receive said seed packet and said receiving member.

17. The apparatus of claim 16 wherein said packet cover is waterproof.
